(19) United States
(12) Patent Application Publication
(10) Pub. No.: US 2013/0199658 A1
(43) Pub. Date: Aug. 8, 2013

(54) Ice Hole Preservation Device

(71) Applicant: Howard Henley, Sheet Harbour (CA)

(72) Inventor: Howard Henley, Sheet Harbour (CA)

(21) Appl. No.: 13/364,393

(22) Filed: Feb. 2, 2012

(51) Int. Cl. F16L 55/00

(52) U.S. Cl. 138/96 R

(57) ABSTRACT

Disclosed is an ice hole plug comprising an elongated pipe member, an end cap closing off one end of the pipe and having a pneumatic valve, along with a bracket attachable to the pipe exterior. The pipe is placed through a hole in a layer of ice that provides access to a body of water therethrough, wherein the pipe bracket prevents the pipe from falling through the hole. An air pump is then connected to the pneumatic valve to pressurize the pipe and force liquid from its interior, preventing the pipe from freezing closed. The pipe brackets further provide a means to weight the device and counteract its buoyancy during pressurization. Once installed, the pipe retains the hole over a prolonged period, preventing hole closure due to freezing and ice accumulation. The hole and water under the ice is the accessible by removing the end cap.

### BACKGROUND OF THE INVENTION

1. Field of the Invention

The present invention relates to an ice hole plug. More specifically, it relates to an improved ice hole plug that prevents the hole from refreezing when not in use over a prolonged period of time, whereafter the plug may be used to access a body of water beneath the layer of ice for fishing or water retrieval purposes.

Lakebeds and bodies of water in colder climates develop a thick layer of ice over their surface during winter months. In these colder climates, it is well known that a frozen body of water generally contains an abundance of fresh, unfrozen water under its layer of ice, along with its associated resources that may be desired. When a body of water freezes, water in proximity to the surface undergoes a change in state, leaving the deeper water unfrozen. This occurrence is caused by the insulating properties of water. The upper surface of a body of water is exposed to cold air, which will more rapidly freeze and transition into a layer of ice. This ice insulates the water below and prevents further freezing. Another reason lakes do not freeze solid is the water begins to lose density as it gets colder, becoming least dense in a frozen state. As water becomes colder it rises to the surface and freezes to the layers of ice already present. This process repeats itself, and would eventually cause an entire lake or river to freeze, however warmer seasons generally arrive before this can occur, thereby preventing the lake from freezing solid.

In these areas, the access to fresh water and its abundant resources is shrouded by the ice layer in winter months, reducing its accessibility. Common methods of accessing the water include penetrating the ice using a hand tool or larger drilling tool that creates an open hole through the ice. This allows access to the water therebelow, but for a limited amount of time. After its initial use and over a period of time, the water filling the hole will refreeze, eliminating access through the hole. This is a common problem for ice fisherman and for those that need consistent access to the water supply who cannot otherwise vigilantly maintain the hole over period of time. Further still, the tools and time required to access the water after a hole as refrozen and unmaintained, or if one was never created, is a considerable burden. This is particularly true in emergency situations wherein more immediate access may be required.

Individuals generally interested in ice holes or retainment of ice holes over a period of time include ice fisherman, those requiring a source of fresh water, and emergency responders requiring a water source to combat a fire or similar immediate situation. Ice fishermen generally utilize an ice shanty or shelter that is placed over a frozen lake surface. After a suitable location is found, a hole must be drilled into the ice to access the water below. This is accomplished with an ice saw, chisel, hand auger, or power auger. This can be a very time consuming and difficult task. In addition, for ice fishermen, this poses a serious problem because the drilling scares away fish in the vicinity. Preferably, drilling operations that cause noise should be limited so as not to spook the fish, or ideally once the hole is created, it can be retained throughout the season with redrilling or maintaining its structure using these tools.

To prevent the additional time and effort of drilling multiple holes, ice fishermen use the same hole throughout the fishing season. This is especially true in areas where ice shanties are utilized. The problem, however, is that an ice hole is left unattended over periods of time, allowing water within the hole to rise up to the opening freeze over. When temperatures drop well below local freezing point, which is common at night in many areas, it becomes very difficult to keep a fishing hole from freezing for any period of time. An ice hole that freezes requires more work to reopen the hole and constant maintenance, thereby adding unnecessary work, time and energy away from fishing or accessing the water therebelow.

Other groups requiring access to water on frozen lakes are those who rely on the lakes to supply their cottages with drinking water and water for emergency responders. In some remote areas, there are no fresh water supplies except for what can be found under the ice. For these groups, it is not a matter of recreation to keep the ice holes open, but a matter of finding a fresh water source without constant maintenance of the hole over a long period. The present invention provides a means to retain a hole through a layer of ice above a body of water for extended periods of time, independent of the outside air temperature, using a tool that prevents water from backfilling into the hole. By maintaining the hole, access to the water below the ice surface is granted for the aforementioned reasons and for those requiring access.

2. Description of the Prior Art

Presently, a common way to prevent an ice hole from freezing over is by temporarily plugging the hole during the times of inactivity. Some individuals use specially designed devices of varying complexity to keep the holes from refreezing. Many of the devices that are currently available or disclosed in the prior art, however, utilize pressurizable bladders and closed cell foam, which are easily damaged when placed in an ice hole and compressed by the expanding ice within the hole. The present invention utilizes an elongated, cylindrical and hollow pipe member, an end cap enclosing one end of the pipe and having a pneumatic valve for enabling pressurization of the pipe, along with an external bracket attachable to the pipe. This design enables a user to place the pipe into the hole, while the bracket prevents fall-through, after which the valve can be used to pressurize the pipe interior and force water from the hole. The bracket is then utilized as a support means to counteract the buoyancy of the now pressurized and submerged pipe. Water is prevented from entering the hole and refreezing, while access to the water is granted by removal of the end can and vacating the pressurized air within the pipe. This robust and simple design is not easily damaged, an can be left unattended for long periods of time, thereby improving life of an existing ice hole and providing a novel device over those in the prior art.

Several devices have been disclosed in the art that attempt to keep an ice hole open. Moore, U.S. Pat. No. 6,526,689 discloses an ice hole fishing plug comprising an elongated cylindrical member which is constructed of a closed cell compressible foam material. While this may be useful for keeping the ice from refreezing, closed cell is fragile and can be easily damaged. If such damage occurs, the device will not maintain a proper seal, causing the ice hole to partially refreeze. In such cases, the ice can crack the foam and defeat the purpose of the device. The present invention is a rigid pipe that is pressurized with air to prevent water from entering the hole and refreezing. The pipe generally is compressed by ice around its exterior, freezing it in place but not compromising its structural integrity and inner air pressure.

Other inventions in the prior art disclose inflatable bladders to plug an ice hole. Schefers, U.S. Pat. No. 4,910,906 discloses a method and apparatus using a pressurizable bladder for maintaining a hole open in outdoor ice atop a body of water. Norwick, U.S. Pat. No. 4,845,875 discloses removable inflatable device for temporarily plugging holes in an ice layer. Christian, U.S. Pat. No. 4,761,909 discloses a bladder constructed of flexible resilient material that is inflated. Similarly, Kooker, U.S. Pat. No. 3,999,322 discloses an inflatable, cone shaped plug for an ice fishing hole composed of flexible material. The problem with using inflatable bladders as an ice plug is that many such devices are prone to rupture much easier than rigid structures. Similarly, these bladders are required to be removed to grant access to the hole and water therethrough. The present invention provides a device that can be retained within the hole, prevent water from rising after pressurization, and grant access to the water through its hollow interior when desired. It does not have to be removed to allow access, and therefore is not affected if frozen into the hole.

Cohee, U.S. Pat. No. 4,218,840 discloses a liner adapted for insertion in an opening formed in ice on the surface of a body of water comprises a generally cylindrical body having at one end a peripheral flange. While this design is similar in structure to the present invention, its purpose is entirely different. The Cohee patent is designed to prevent snow and slush from forming in an already created ice hole, not to plug the ice hole for periods of nonuse. This device fits inside an ice hole, but does not have a means of sealing the ice hole or preventing water from backfilling into the hole and refreezing. The present invention provides a sealed end cap that enables internal pressurization to force water from the hole to prevent this refreezing. When access is required, the end cap is removed and the pipe acts as a hollow member through which a fishing line may be place or a device to draw water may be utilizing therethrough.

The devices disclosed in the prior art involve plugging an ice fishing hole by using pressurizable bladders and closed cell foam. The primary function of such devices is to expand inside the opening in the ice to prevent unfrozen water from coming into contact with the colder air and refreezing. The means by which the devices in the prior art achieve this makes them susceptible to damage when being removed from the ice hole, whereas the present invention is made of a material that is much less susceptible to damage from the cold. The prior art device all must be removed to grant access through the hole, whereas the present invention can maintain its position within the hole and allow access to the water. Removal is not a necessary step with regard to the present invention, therefore limiting the chances of damage thereto during this process. Instead of expanding to prevent water from coming into contact with the air, the present invention forces the water from the hole, thereby preventing the hole from refreezing and keeping the water below the ice layer surface wherein it is less susceptible to freezing.

In light of the prior art and the disclosed elements of the present invention, it is submitted that the present invention substantially diverges in design elements from the prior art. Consequently it is clear that that present invention is not described by the art and that a need exists for an improved ice hole plug that prevents freezing when not in use, while allowing access to the hole without requiring removal of the plug. In this regard the instant invention substantially fulfills these needs.

### SUMMARY OF THE INVENTION

In view of the foregoing disadvantages inherent in the known types of ice hole plugs now present in the prior art, the present invention provides a new ice hole plug wherein the same can be utilized for providing convenience for the user when used to prevent an ice hole from refreezing when not in use.

It is therefore an object of the present invention to provide a new and improved ice hole plug for installation into an ice hole that has all of the advantages of the prior art and none of the disadvantages.

Another object of the present invention to provide a means to temporarily plug an ice hole that prevents water from re-entering the hole and freezing when not in use.

Another object of the present invention is to provide an ice hole plug that is pressurizable to remove water from the hole, while providing a rigid structure that allows access to the hole if desired while still installed.

A further object of the present invention is to provide an ice hole plug that does not utilize deformable, fragile or foam bladders to operate, but rather one that utilizes a rigid structure to maintain a hole opening.

Another object of the invention is to provide an ice hole plug which is convenient to assemble, use, and transport.

A final object of the present invention is to provide an ice hole plug that allows access to the water therethrough for various purposes, including ice fishing, water retrieval and water pump attachment for emergency responders.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of the present invention in a working position within an ice hole, wherein its end cap is secured to the pipe to preserve air pressure therewithin and a bracket above the ice surface is positioned to support the device in a static position.

FIG. 2 shows a side view of the present invention in a working position within an ice hole and coupled to a pneumatic pump device for forcing air into the device's interior volume to evacuate water therefrom.

FIG. 3 shows a perspective view of an embodiment of the pipe bracket utilized around the exterior of the hole plug pipe.

### DETAILED DESCRIPTION OF THE INVENTION

Reference is made herein to the attached drawings. Like reference numerals are used throughout the drawings to depict like or similar elements of the ice hole fishing plug. For the purposes of presenting a brief and clear description of the present invention, the preferred embodiment will be discussed as used for retaining an ice fishing hole for a prolonged period. The figures are intended for representative purposes only and should not be considered to be limiting in any respect.

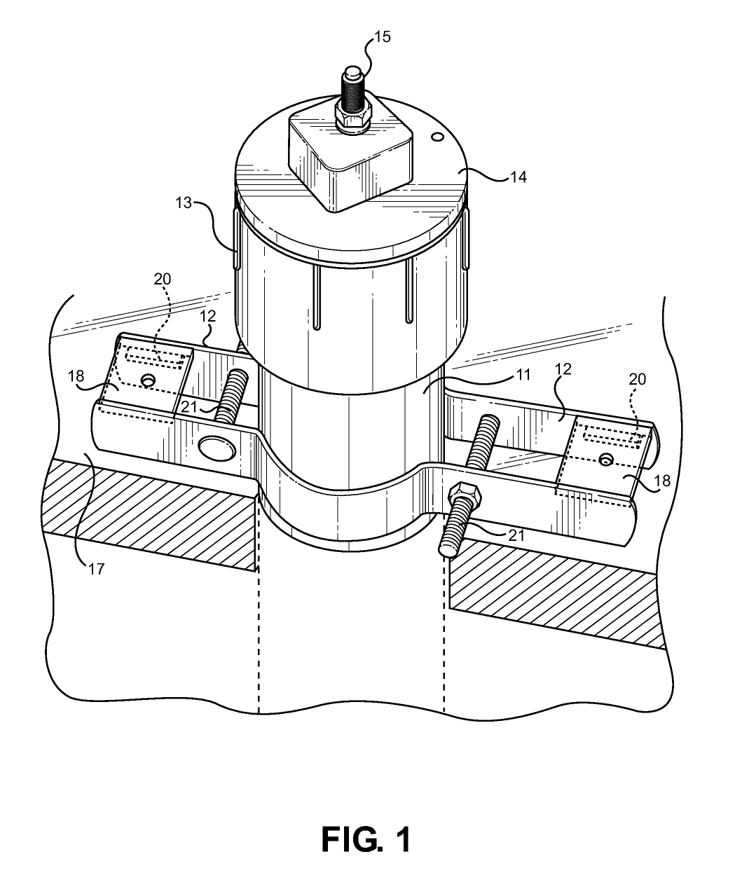

Referring now to FIG. 1, there is shown a perspective view of the present invention, which comprises an elongated, cylindrical and hollow pipe member 11 having an upper and lower end. The pipe 11 is adapted to accommodate the diameter and depth of the hole in the ice 17, wherein the lower end of the pipe extends at least as far as the depth of the hole. The pipe 11 upper end comprises an end cap 14 that encloses the pipe end in an air tight fashion, wherein the end cap further comprises a pneumatic valve 15 fitting for enabling pressurization of the pipe interior. Around the exterior of the pipe 11 is a bracket 12 that is adapted to attach to the sides of the pipe and serve dual functions. First, the bracket 12 prevents the pipe 11 from simply falling through the hole when inserted, and second, the bracket 12 provides a counter weight to combat the buoyancy of the pipe once pressurized. Pressurization of the pipe 11 once positioned into the hole and supported by the bracket 12 flushes water from the pipe interior and from the hole, thus preventing any water from backfilling into the hole and refreezing, thus closing off access through the hole.

An end cap 14 is secured to the upper end of the pipe 11 to provide an air tight seal thereon, wherein the end cap may comprise an embodiment using a threaded cap assembly 13 and removable end cap 14. In the preferred embodiment, the end cap assembly comprises a shoulder portion 13 with a threaded cap 14 and a rubber o-ring to maintain a tight seal. The end cap assembly is similar in shape and function to a sewer cleanout, and provides threads for attachment of the end cap assembly 13.

Along the top of the end cap 14 is a pneumatic valve 15 that allows connection of an air pump device for inserting air into the interior of the pipe 11. The pipe, once inserted, has a volume of water therein as water attempts to refill the ice hole. Air forced through the pneumatic valve, which may comprise of a check valve, Schrader valve, snifter valve or similar air valve, displaces the water within the pipe and forces it through its open lower end. The water is vacated from the ice hole within the interior of the pipe, thus preventing this conduit from refreezing and shutting of access to the water through the interior of the pipe. In this way, an ice hole may be preserved over long periods of time between activity with little to not maintenance of the hole. The pipe 11 may freeze into the hole, as water around its outer circumference freezes, however access is permitted therethrough the pipe by removing the end cap 14 and thus depressurizing the pipe and utilizing its hollow construction to regain access to the water below.

The bracket 12 that is used to support the pipe 11 within the hole and counteract buoyancy may take several forms. It is desired to disclose a bracket that serves as a flanged element, preventing pipe fall-through, while also permitting weighted support therefore. The weight may be integral to the bracket, wherein its mass is such that it acts as a counterweight, or alternatively the bracket may be adapted to be loaded with external weights, such as sand bags or other external weighted means. A final embodiment allows for a fastener to be driving into the ice and through the bracket, secure the bracket against the upper surface of the ice layer 17. As shown in FIG. 1, an embodiment of the bracket comprising two connectable 21 members is provided, wherein a shelf 18 and ledge 20 provide a means to place weighted objects, or a fastener may be driven through a fastener hole in the shelf 18 and into the ice layer for securement.

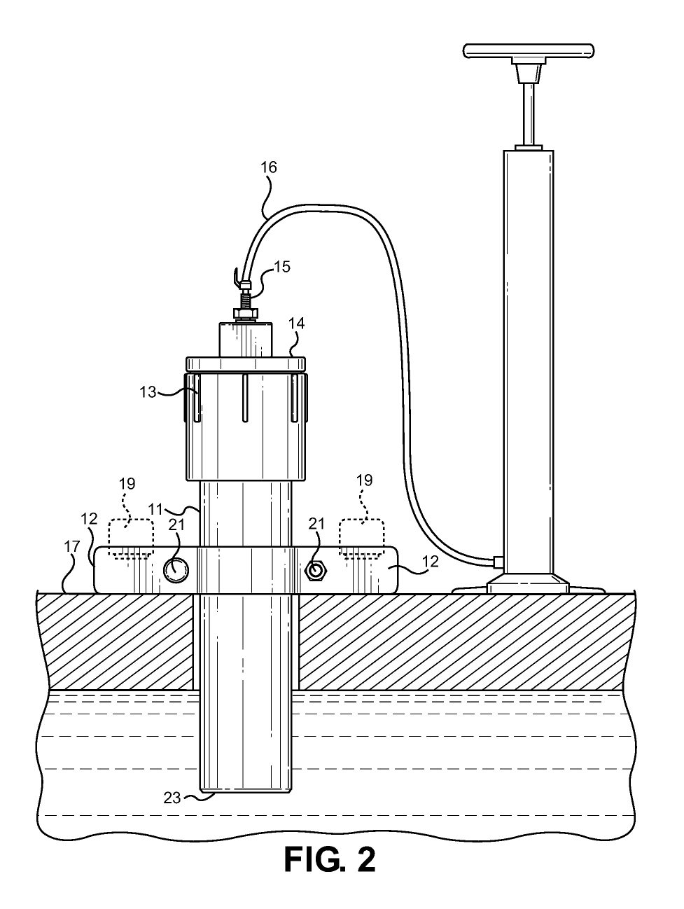

Referring now to FIG. 2, there is shown a side view of the present invention in a working position and connected to a pneumatic pump device for pressurization of the pipe interior. The pump may be a sophisticated air pump mechanism, or alternatively a standard pneumatic hand pump. A hose 16 from the pump is connected to the pneumatic valve 15 on the pipe end cap 14 to allow air to be inserted into the pipe for the purposes of flushing water from its interior. To prevent the fishing hole from freezing when not in use, the pipe 11 is inserted downwardly into the ice hole that has been previously drilled until the bracket 12 rests on the ice layer 17 upper surface. The length of the pipe 11 is sized to extend through the layer of ice to prevent ice formation therein, as shown. The threaded cap 14 is threadably attached to the end cap 13 to secure the top of the pipe 11, after which pressurization of the pipe may be achieved.

The amount of air pressure within the hollow member should be kept to an amount that prevents water from backfilling into the pipe interior. In practice, it has been shown that approximately two pounds per square inch of air, measured as gage pressure, is sufficient to evacuated water from the pipe interior. This value can fluctuate depending on the depth of the pipe into the body of water, as the water pressure at the end of the pipe increases with depth and thus requires greater pressurization to evacuate the water completely from the pipe interior. The deeper the pipe is inserted into the water, the greater the force of buoyancy on the lower end of the device once pressurized and evacuated of water. To counteract this, weights 19 may be placed onto the bracket 12 that is secured 21 around the exterior of the pipe 11. Alternatively, weighted brackets 12 may be utilized that required no additional weight to counteract the pipe buoyancy.

Pressure within the pipe can further be monitored with a standard air pressure gauge attachable to the valve 15. Users can monitor this pressure, and based on the length of the pipe and its depth, will be able to know when the pipe is evacuated of water. In an alternate embodiment, the end cap 14 may be provided with a transparent window through which to monitor the water level within the pipe. A graduated water level along the inside of the pipe, along with visualization thereof once installed, allows a user to know precisely whether all water has been evacuated from the ice hole interior. Once installed, pressurized and evacuated of water, water is kept out of the ice hole and below the ice layer wherein remains separated from the outside air temperature. The temperature below the surface is above freezing and is less prone to freezing, preventing ice buildup or the hole from freezing. It may not be required to completely evacuate the pipe interior of water if the pipe lower end is placed at a sufficient depth so as to surround it with higher temperature surrounding water. The water at the extremity of the pipe will not readily freeze, and therefore it is sufficient to clear the ice hole through the ice layer only, wherein lower temperature air is still able to lower the water temperature sufficient to its freezing point.

When access to the ice hole is desired, the threaded cap 14 is removed, rapidly releasing the pipe internal air pressure. This allows the water to rise up to lake level. The valve 15 may also be depressed if slower depressurization is desired. If the pipe has been in place for an extended period, it is most likely frozen into place. The user may remove the threaded cap 14 and feed a fishing line through the pipe interior for fishing purposes, or alternatively a water retrieval means may be connected or fed through the pipe 11 for water access thereto. If removal is required, the pipe may be manually removed using tool to break the ice build-up around the pipe outer diameter. The pipe 11 may be kept within the hole for extended periods if desired, wherein periodic access may be achieved by depressurizing and re-pressurizing the pipe 11 before and after use. It has been shown that the pressure within the pipe 11 will maintain for extended periods with minimal decay. Decay of pressure is only permitted through percolation of the high pressure air into the water at the end of the pipe, which is a slow process that is easily compensated for by over-pressurizing the pipe and regular monitoring of the pipe pressure.

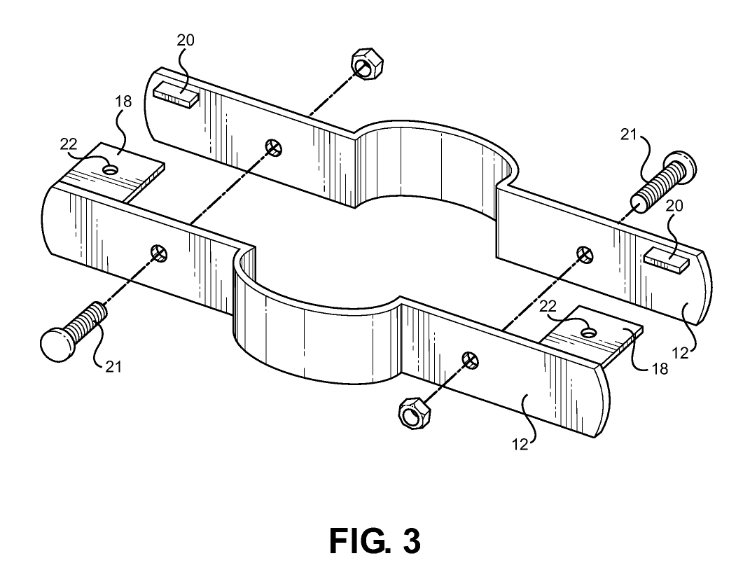

Referring now to FIG. 3, there is shown an overhead perspective view of an embodiment of the pipe bracket 12 in an exploded configuration. As shown, this embodiment employs two adjoining sections 12 that are fastened 21 together around the exterior of the pipe to keep the pipe from falling through the hole and to allow counterbalancing its inherent buoyancy once pressurized and displacing a quantity of water. Two shelves 18 are provided that are supported by opposing ledges 20, wherein the shelves 18 act as support for weights to be placed thereon. A fastener hole 22 through the shelf 18 may further be provided to drive a fastener through the bracket 12 and into the layer of ice for securement of the entire assembly. It is desired, as previously noted, to disclose a bracket having extended wings or members that act as a catch for the pipe, wherein it is prevented from falling through the hole. Further, the bracket may be a weighted member, having a sizable mass to balance the force of buoyancy given the length of pipe, or provide a means to support a weighted object, such as a sandbag or block. Any object providing these functions is contemplated.

The present invention may be constructed of any suitable material that is corrosion resistant and is able to maintain an internal pressure with minimal expansion that would prevent water backfill therein. Materials such as PVC, ABS plastic, stainless steel, aluminum, or rubber are contemplated. Likewise, the bracket may be constructed of any material or form that prevents the hollow member from falling through the ice and one that provides sufficient weight to counterbalance the buoyancy provided to the device by the column of air above the surface of water.

Overall, the device provides a means to access water through an ice layer for any purpose, wherein a hole is maintained and prevented from freezing closed over an extended period of time. Once installed, the hole requires little to no maintenance, and allows a user to return and restart activity utilizing the hole after inactivity and neglect. As long as the pressure is maintained within the pipe, the water will not backfill the hole and refreeze. The device may be utilized for any number of purposes in colder climates, including ice fishing, water access and as a hookup for a water pump for various activities including fire fighting and emergency services.

With regards to the present disclosure, it is submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An ice hole plug, comprising:
an elongated, cylindrical and hollow pipe member having an upper and lower end;
an end cap assembly removably attaching pipe upper end, said end cap having a pneumatic valve for injecting air into said pipe interior for pressurization;
a bracket attachable around said pipe exterior;
said bracket adapted to prevent said pipe from falling through an ice hole and counterweighing said pressurized pipe once installed into an ice hole;
said pressurization adapted to evacuate water from said pipe interior once installed into an ice hole.

2) The device of claim 1, wherein said bracket further comprises a shelf region to support a counter weight.

3) The device of claim 1, wherein said bracket further comprises a mean to fasten said bracket to said ice layer for securement thereof.

4) The device of claim 1, wherein said bracket further comprise adjoining sections having a shelf region supported by an opposing ledge, said sections fastenably secured about said pipe exterior.

5) The device of claim 4, wherein said shelf region further comprises a fastener hole for supporting a fastener driven into said ice layer of securement.

6) The device of claim, 1 wherein said end cap assembly provides threadable engagement of said top cap to provide secure fitment during pressurization of said pipe.

7) The device of claim 1, wherein said end cap further comprises a transparent window for visualizing said pipe interior during pressurization.

8) The device of claim 7, wherein said pipe interior further comprises a graduated line to indicate a water level within said pipe during pressurization.
